(19) United States
(12) Patent Application Publication
(10) Pub. No.: US 2011/0273134 A1
(43) Pub. Date: Nov. 10, 2011

(54) IMPELLER DEVICE AND AUTOMATIC-SWITCHING REGENERATIVE CHARGING SYSTEM BETWEEN KINETIC ENERGY AND WIND ENERGY

(76) Inventors: Fung Ling Tsang, Hong Kong (CN); Cherry Chang, Hong Kong (CN); Hoikwan Tsang, Hong Kong (CN)

(21) Appl. No.: 13/130,318

(22) PCT Filed: Jan. 20, 2010
(86) PCT No.: PCT/CN2010/070293

§ 371 Date: May 20, 2011

(30) Foreign Application Priority Data
Jan. 21, 2009 (CN) 200920001722.3

(51) Int. Cl. F03D 9/02

(52) U.S. Cl. 320/101

(57) ABSTRACT

An impeller device and an automatic-switching regenerative charging system between kinetic energy and wind energy are disclosed. The charging system comprises an electric generator and an impeller device in an electric green vehicle. An input end of the impeller device is connected to a differential device or an output shaft of a transmission box connected with the differential device. An output end of the impeller device is connected to an input shaft of the electric generator. The impeller device comprises at least one toothed disk with meshing teeth or at least one drive pulley. By connecting or disconnecting the impeller device and the differential device or the transmission box that link to the differential device through the one-way clutch, the kinetic energy of the electric green vehicle or the wind energy produced by the movement of the electric green vehicle can be automatically switched to charge an accumulator cell.

### BACKGROUND OF THE INVENTION

1. Field of the Invention

The present invention relates to an electric green vehicle; and more particularly to an impeller device and an automatic switching regenerative charging system between kinetic energy and wind energy.

2. Description of the Prior Art

People have become increasingly concerned about the environment protection, so that the electric green vehicle will become more and more popular. Referring to FIG. 1 which is a working principle diagram of a conventional electric green vehicle, electric energy is outputted from an accumulator cell 1 to PWM (pulse width modulation) chopper 2 and a control system 5 first, and then the PWM chopper 2 and the control system 5 will control a traction motor 3 to drive the electric green vehicle through a differential device 4. The accumulator cell 1 needs to be charged by external power supplies. Therefore, an electric green vehicle with a solar charger for the accumulator cell 1 was devised but wasn't widely used due to the shortcomings that the solar energy is unavailable in cloudy days or at night, and it puts too many limitations on the color and shape of the vehicle.

The present invention has arisen to mitigate and/or obviate the afore-described disadvantages.

### SUMMARY OF THE INVENTION

The primary objective of the present invention is to provide an automatic switching regenerative charging system between kinetic energy and wind energy which can utilize the kinetic energy of the electric green vehicle itself and the wind energy produced by the movement of the electric green vehicle to charge an accumulator cell.

The second objective of the present invention is to provide an impeller device used in a regenerative charging system.

To achieve the above objectives, the automatic switching regenerative charging system between kinetic energy and wind energy comprises an electric generator, and an impeller device that are directly disposed in an electric green vehicle. Through a central shaft and a one-way clutch, an input end of the impeller device is connected to the output shaft of a differential device or connected to the output shaft of the transmission box that link with the differential device. An output end of the impeller device is connected to an input shaft of the electric generator.

The impeller device comprises at least one toothed disk with meshing teeth, the toothed disk is centrally formed with a central hole to be connected to a central shaft, the toothed disk is provided one at least one side thereof with plural blades radially distributed from the central hole to the meshing teeth, the respective blades have a first end connected to the toothed disk, and a second end of the respective blades is connected to a round disk which seals plural spaces defined by the plural blades.

Alternatively, the impeller device comprises at least one drive pulley, the drive pulley is centrally formed with a central hole to be connected to a central shaft, the drive pulley is provided on at least one side thereof with plural blades radially distributed from the central hole, the respective blades have a first end connected to the drive pulley, and a second end of the respective blades is connected to a round disk which seals plural spaces defined by the plural blades.

The blades are flat or curved.

A central casing is engaged on the central shaft and disposed between the toothed disk and the round disk for fixing the blades.

A central casing is engaged on the central shaft and disposed between the drive pulley and the round disk for fixing the blades.

The toothed disk of the impeller device is connected to the input shaft of the electric generator through an inert gear and a driven gear.

The drive pulley is connected to the input shaft of the electric generator through a driven pulley.

The electric green vehicle is formed with air holes in a vehicle body thereof.

The blades are connected to the toothed disk and the round disk by welding or by inserting the blades in grooves formed in the toothed disk and the round disk or by a connecting element which is inserted through holes formed in the blades, the toothed disk and the round disk.

The blades are connected to the drive pulley and the round disk by welding or by inserting the blades in grooves formed in the toothed disk and the round disk or by inserting a connecting element into holes formed in the blades, the toothed disk and the round disk,

The impeller device of the present invention is provided with one at least one side of the toothed disk or the drive pulley with the plural blades which form a spinning wheel shape, so that when the electric green vehicle is started, the one-way clutch can connect or disconnect the impeller device and the differential device or the transmission box that link to the differential device to switch the kinetic energy of the electric green vehicle itself and the wind energy produced by the movement of the electric green vehicle automatically, making the generator generate electricity to charge the accumulator cell connected to the electric green vehicle. By such arrangements, the present invention can realize the purposes of energy utilization and environment protection.

### BRIEF DESCRIPTION OF THE DRAWINGS

FIG. 1 is a working principle diagram of a conventional electric vehicle;

FIG. 2 is a working principle diagram of an electric green vehicle which is equipped with an impeller device comprising at least one toothed disk in accordance with the present invention;

FIG. 3 is a perspective view of the impeller device in accordance with the present invention;

FIG. 4 is a side view of the impeller device in accordance with the present invention;

FIG. 5 is a bottom view of the impeller device of FIG. 4 in accordance with the present invention;

FIG. 6 is a top view showing that the impeller device in accordance with the present invention is installed in the electric green vehicle;

FIG. 7 is a side view showing that the impeller device in accordance with the present invention is installed in the electric green vehicle;

FIG. 8 is a working principle diagram of an electric green vehicle which is equipped with an impeller device comprising at least one drive pulley in accordance with the present invention;

FIG. 9 is a perspective view of the impeller device comprising the at least one drive pulley in accordance with the present invention;

FIG. 10 is a side view of the impeller device comprising the at least one drive pulley in accordance with the present invention;

FIG. 11 is a top view of the impeller device of FIG. 10;

FIG. 12 is a top view of the electric green vehicle which is equipped with the impeller device comprising at least one drive pulley in accordance with the present invention; and

FIG. 13 is a side view of the electric green vehicle which is equipped with the impeller device comprising at least one drive pulley in accordance with the present invention.

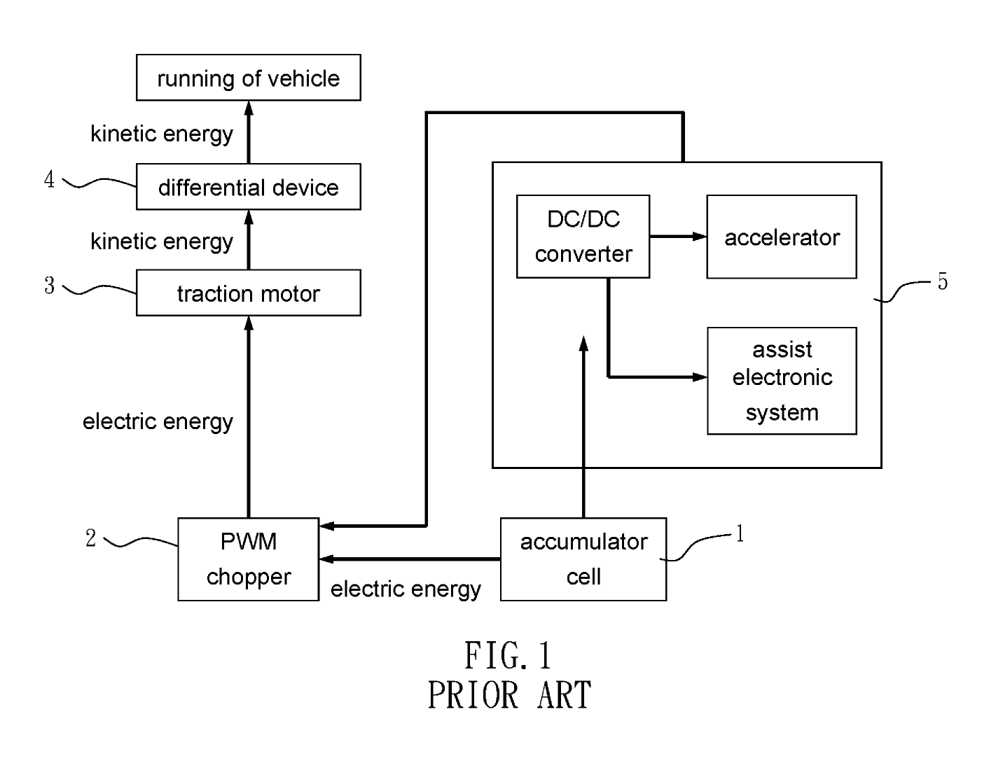

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

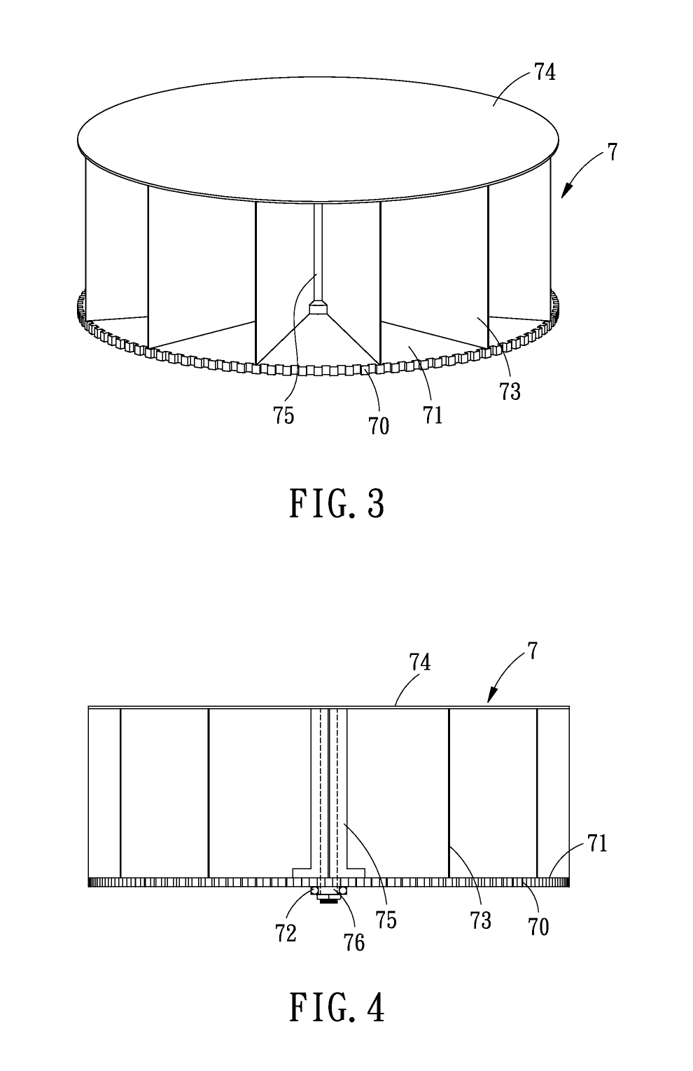

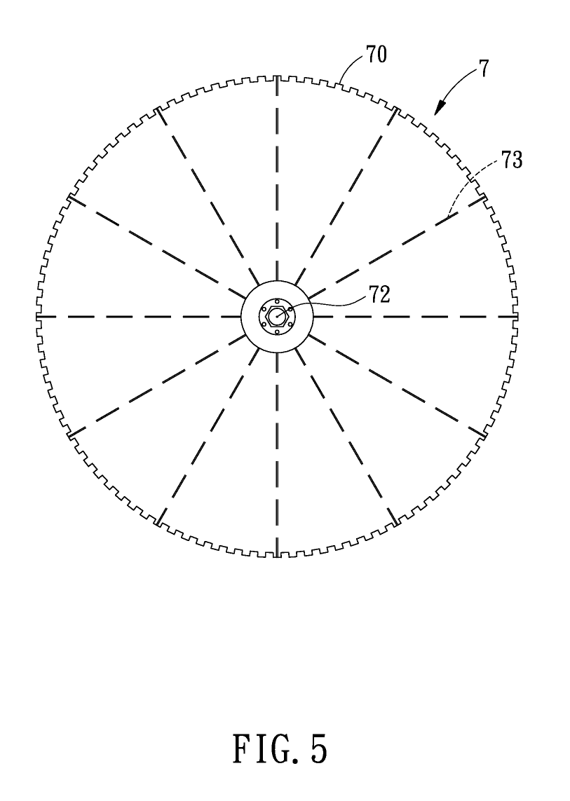

Referring to FIGS. 3-5, an impeller device 7 in accordance with a first embodiment of the present invention comprises at least one toothed disk 71 with meshing teeth 70. The toothed disk 71 is centrally formed with a central hole 72 for insertion of a central shaft 76. The toothed disk 71 is provided on at least one side thereof with plural blades 73 radially distributed from the central hole 72 to the meshing teeth 70, as shown in FIG. 5. The respective blades 73 have a first end connected to the toothed disk 71, and a second end of the respective blades 73 is connected to a round disk 74 which seals plural spaces defined by the plural blades 73, that is, the plural blades 73 are connected between the toothed disk 71 and the round disk 74. The plural blades 73 are connected to the toothed disk 71 and the round disk 74 by welding or by inserting the blades 73 in grooves formed in the toothed disk and the round disk or by inserting a connecting element into holes formed in the blades, the toothed disk and the round disk. All those connecting means are easy to realize for one skilled in the art, so further explanation are omitted herein.

To further strengthen the connection of the blades 73 to the toothed disk 71 and the round disk 74, a central casing 75 which can be engaged on the central shaft 76 for fixing the blades 73 is disposed between the toothed disk 71 and the round disk 74.

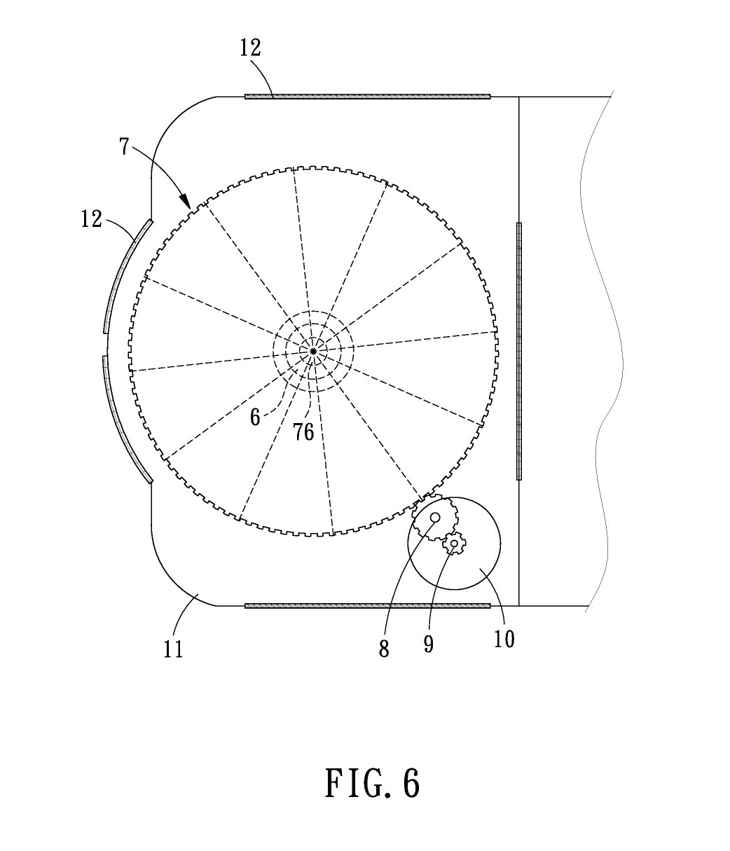

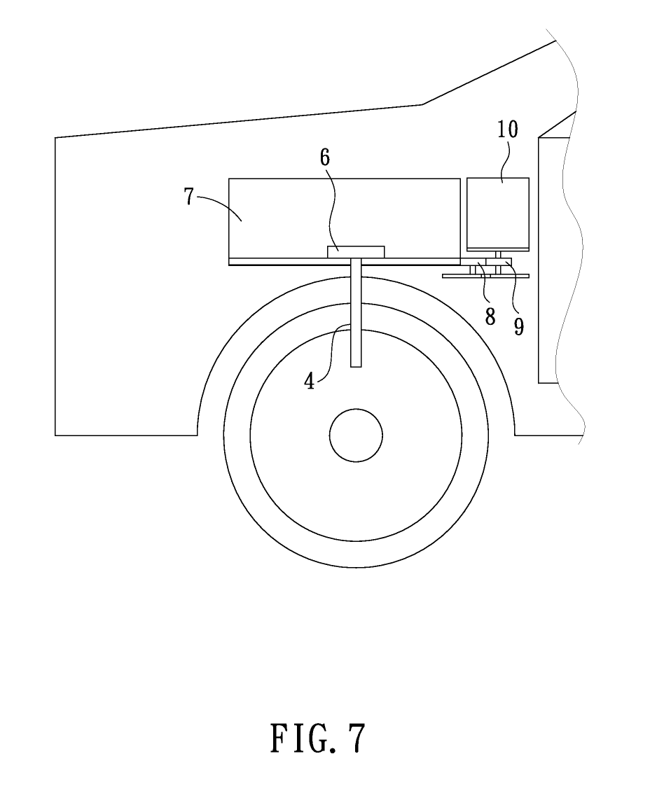

An automatic switching regenerative charging system between kinetic energy and wind energy in accordance with a first embodiment of the present invention, as shown in FIGS. 6-7, comprises an impeller device 7, a clutch 6, an inert gear 8 and a driven gear 9 that are directly disposed in a vehicle body 11 formed with air holes 12. An input end of the impeller device 7 is connected to a differential device 4 of the electric green vehicle through the central shaft 76, and the clutch 6. The differential device 4 rotates the impeller device 7 while driving the electric green vehicle to move. The regenerative charging system further comprises an electric generator 10 which is disposed in the electric green vehicle and connected to an accumulator cell 1. An input shaft of the electric generator 10 is connected to the meshing teeth 70 of the toothed disk 71 though a driven gear 9, namely connected to the output end of the impeller device 7, and the inert gear 8. When rotating, the impeller device 7 will drive the inert gear 8 and the driven gear 9 to rotate, further driving the electric generator 10 to work. With the arrangement of the inert gear 8 and the driven gear 9, the rotating speed of the driven gear 9 can be increased more than ten times of that of the impeller device 7, that is, the rotating speed of the driven gear 9 will be high enough to make the electric generator 10 to generate electricity so as to output electric energy.

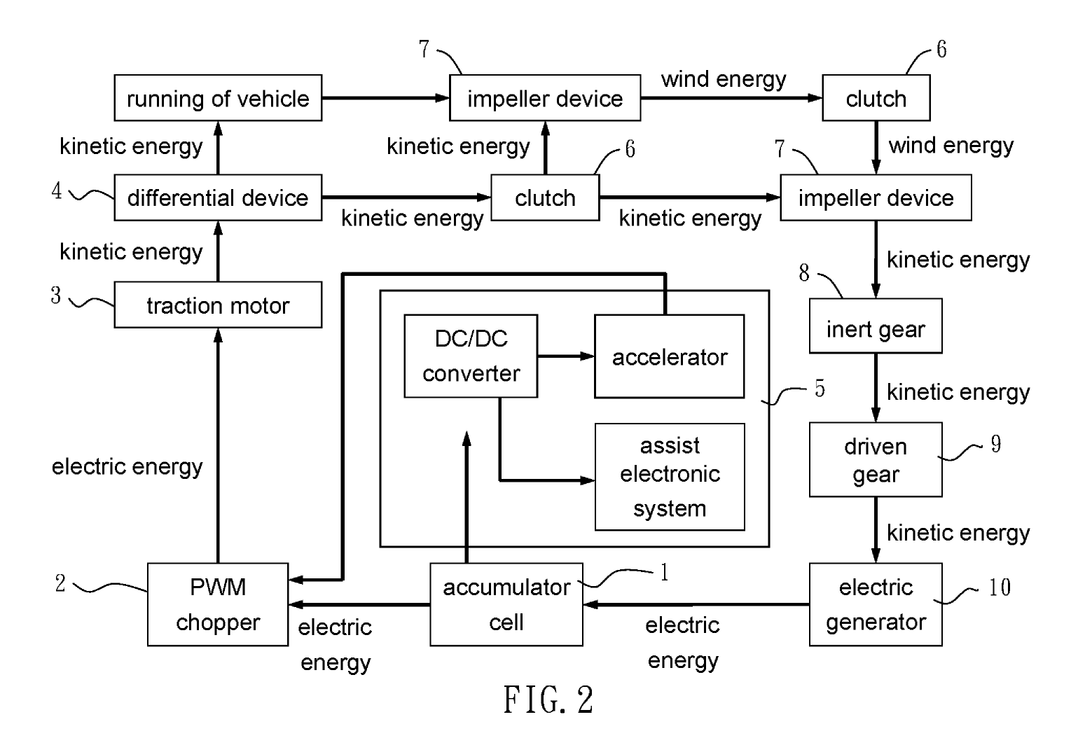

The working principle for the automatic switching regenerative charging system between kinetic energy and wind energy in the present embodiment is as shown in FIG. 2, when the electric green vehicle is started, the one-way clutch 6 will connect the differential device 4 to the impeller device 7 to utilize the kinetic energy of the electric green vehicle itself to drive the impeller device 7 to rotate, charging the accumulator cell 1. After the electric green vehicle achieves a certain speed, airflow will be formed outside the electric green vehicle and make the rotating speed of the impeller device 7 higher than the rotating speed provided by the differential device 4. At this moment, the one-way clutch 6 will disconnect the impeller device 7 from the differential device 4. The airflow formed during the driving process of the electric green vehicle will be utilized to drive the impeller device 7 to rotate so as to further drive the inert gear 8 and the driven gear 9 to rotate, making the electric generator 10 generate electricity to charge the accumulator cell 1. The present invention is environment-friendly since it can reduce the required energy to charge the accumulator cell as well as the number of times of charging with external power supply. When the electric green vehicle slows down and the airflow formed does not have enough speed to drive the impeller device 7, the one-way clutch 6 will reconnect the impeller device 7 and the differential device 4, reutilizing the kinetic energy of the electric green vehicle itself to generate electricity.

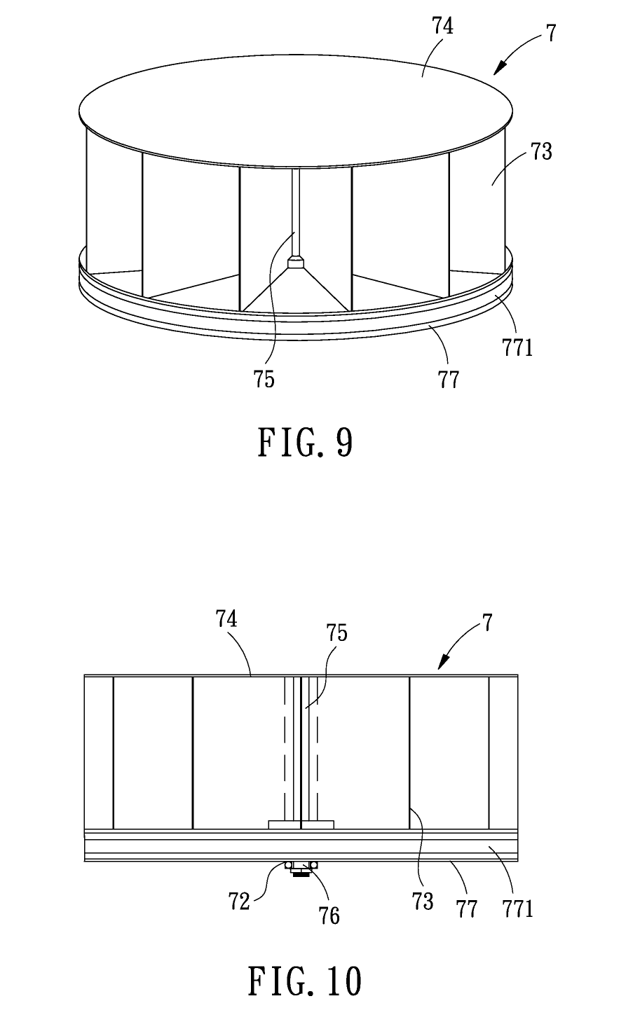

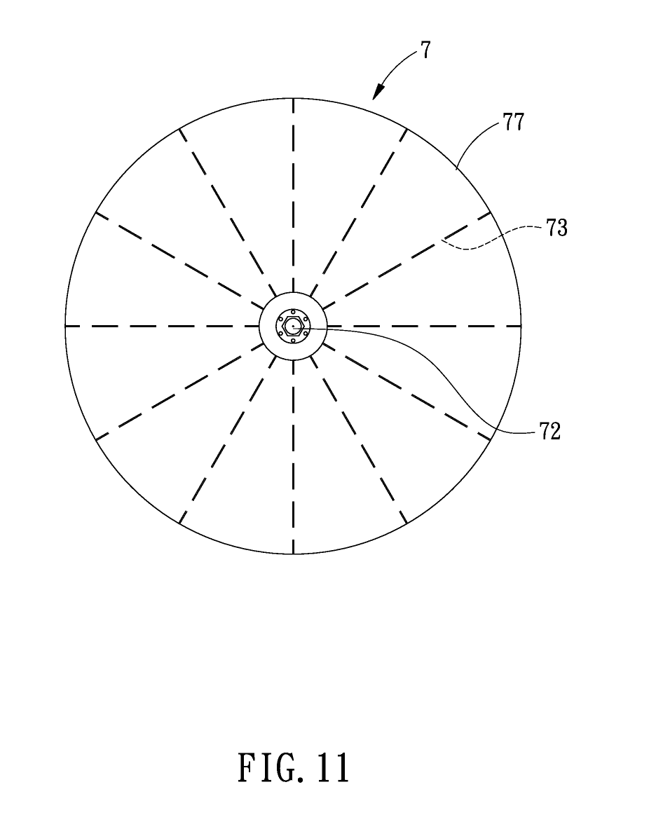

Referring to FIGS. 9-11, an impeller device 7 in accordance with a second embodiment of the present invention comprises at least one drive pulley 77 which is formed with a belt groove 771. The drive pulley 77 is centrally formed with a central hole 72 to be connected to a central shaft 76. As shown in FIG. 11, the drive pulley 77 is provided on at least one side thereof with plural blades 73 radially distributed from the central hole 72. The respective blades 73 have a first end connected to the drive pulley 77, and a second end of the respective blades 73 is connected to a round disk 74 which seals plural spaces defined by the plural blades 73. The blades 73 are connected to the drive pulley 77 and the round disk 74 by welding or by inserting the blades 73 in grooves formed in the toothed disk and the round disk or by inserting a connecting element into holes formed in the blades, the toothed disk and the round disk. All those connecting means are easy to realize for one skilled in the art, so further explanation are omitted herein.

To further strengthen the connection of the blades 73 to the drive pulley 77 and the round disk 74, a central casing 75 which can be engaged on the central shaft 76 for fixing the blades 73 is disposed between the drive pulley 77 and the round disc 74.

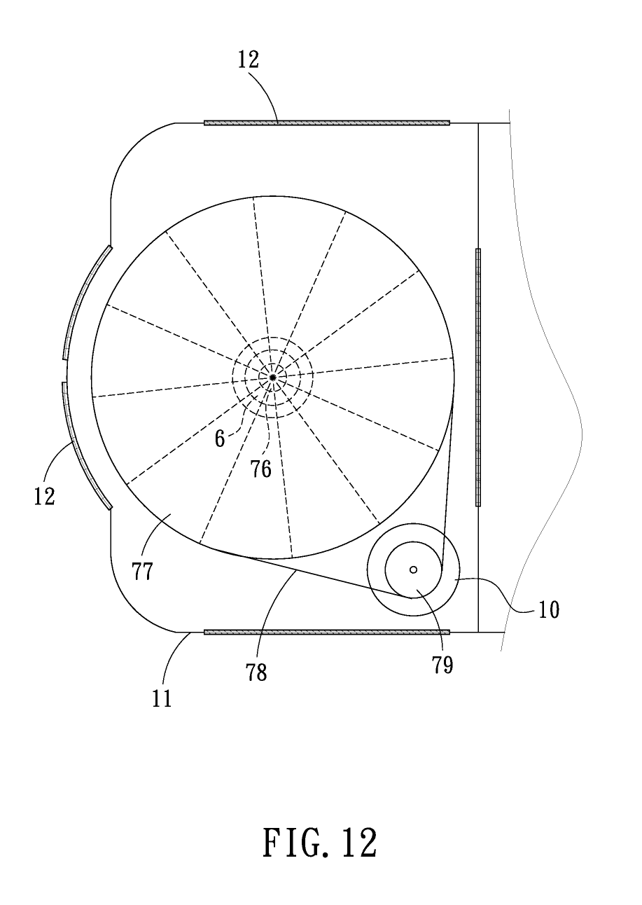

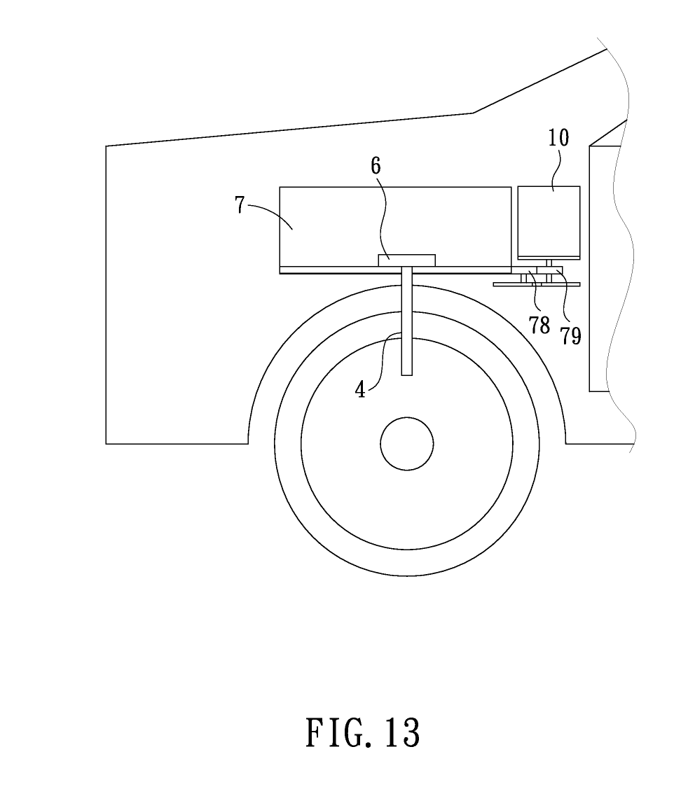

An automatic switching regenerative charging system between kinetic energy and wind energy in accordance with a second embodiment of the present invention, as shown in FIGS. 12-13, comprises an impeller device 7, a clutch 6, a belt 78 and a driven pulley 79. The impeller device 7, the clutch 6, the belt 78 and the driven pulley 79 are directly disposed in a vehicle body 11 which is formed with air holes 12. The impeller device 7 is connected to an output shaft of a differential device 4 of the electric green vehicle through the central shaft 76, and the clutch 6. The differential device 4 rotates the impeller device 7 while driving the electric green vehicle to move. The regenerative charging system further comprises an electric generator 10 which is disposed in the electric green vehicle and connected to the accumulator cell 1. An input shaft of the electric generator 10 is connected to the drive pulley 77 of the impeller device 7 though the driven pulley 79. When rotating, the drive pulley 77 of the impeller device 7 will drive the driven pulley 79 to rotate, further driving the electric generator 10 to work. With the arrangement of the drive pulley 77 and the driven pulley 79, the rotating speed of the driven pulley 79 will be more than ten times of the rotating speed of the drive pulley 77, that is, the rotating speed of the driven pulley 79 will be high enough to make the electric generator 10 to generate electricity so as to output electric energy.

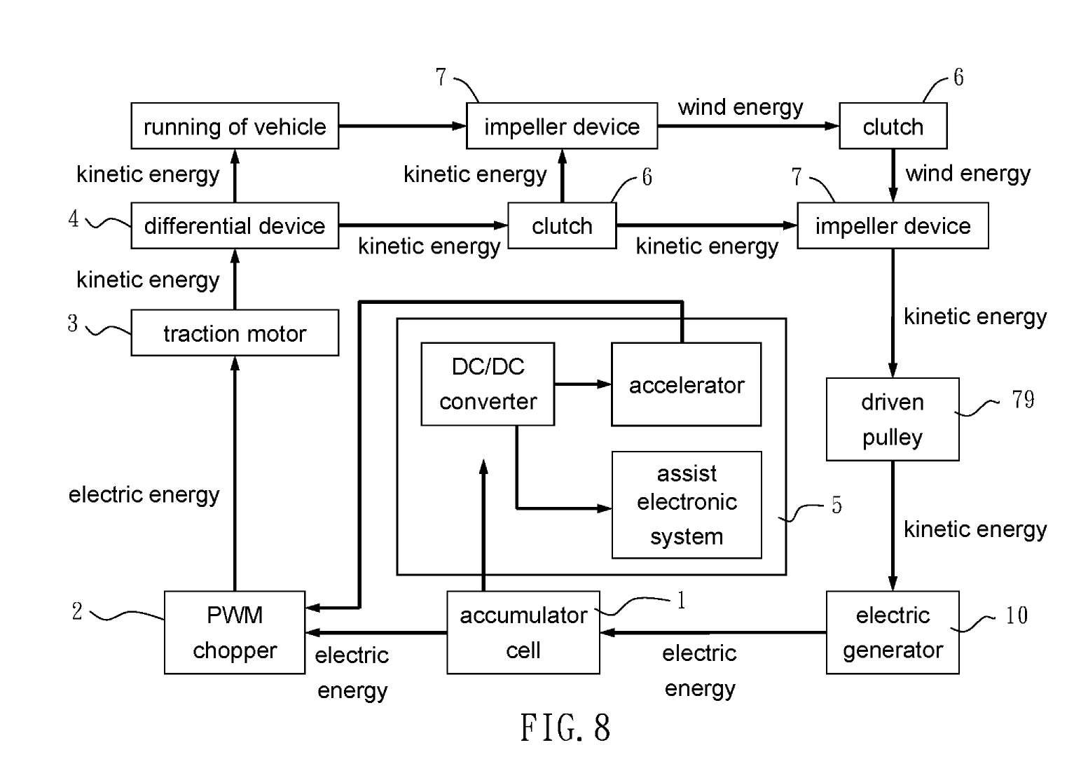

Referring to FIG. 8 which illustrates the working principle for the automatic switching regenerative charging system between kinetic energy and wind energy in the present embodiment, when the electric green vehicle is started, the one-way clutch 6 will connect the differential device 4 and the impeller device 7, recharging the accumulator cell 1 by utilizing the kinetic energy of the electric green vehicle to drive the impeller device 7 to rotate. After the electric green vehicle achieves a certain speed, an airflow having a definite speed will be formed outside the electric green vehicle, and the airflow can make the rotating speed of the impeller device 7 higher than the rotating speed provided by the differential device 4. At this moment, the one-way clutch 6 will disconnect the impeller device 7 from the differential device 4. The airflow formed during the driving process of the electric green vehicle will be utilized to drive the impeller device 7 to rotate to further drive the driven pulley 79 to rotate, making the electric generator 10 generate electricity to charge the accumulator cell 1. The present invention is environment-friendly since it can reduce the required energy to charge the accumulator cell as well as the number of times of charging with external power supply. When the electric green vehicle slows down and the airflow formed does not have enough speed to drive the impeller device 7, the one-way clutch 6 will reconnect the impeller device 7 and the differential device 4, reutilizing the kinetic energy of the electric green vehicle itself to generate electricity.

Furthermore, the blades 73 of the present invention can be flat or curved as desired.

While we have shown and described various embodiments in accordance with the present invention, it is clear to those skilled in the art that further embodiments may be made without departing from the scope of the present invention.

What is claimed is:

1. An impeller device comprising at least one toothed disk with meshing teeth, the toothed disk being centrally formed with a central hole to be connected to a central shaft, the toothed disk being provided on at least one side thereof with plural blades radially distributed from the central hole to the meshing teeth, the respective blades having a first end connected to the toothed disk, and a second end of the respective blades being connected to a round disk which seals plural spaces defined by the plural blades.

2. The impeller device as claimed in claim 1, wherein the blades are flat or curved.

3. The impeller device as claimed in claim 1, wherein a central casing is engaged on the central shaft and disposed between the toothed disk and the round disk for fixing the blades.

4. The impeller device as claimed in claim 1, wherein the blades are connected to the toothed disk and the round disk by welding or by inserting the blades in grooves formed in the toothed disk and the round disk or by a connecting element which is inserted through holes formed in the blades, the toothed disk and the round disk.

5. A impeller device comprising at least one drive pulley, the drive pulley being centrally formed with a central hole to be connected to a central shaft, the drive pulley being provided on at least one side thereof with plural blades radially distributed from the central hole, the respective blades having a first end connected to the drive pulley, and a second end of the respective blades being connected to a round disk which seals plural spaces defined by the plural blades.

6. The impeller device as claimed in claim 5, wherein the blades are flat or curved.

7. The impeller device as claimed in claim 5, wherein a central casing is engaged on the central shaft and disposed between the drive pulley and the round disk for fixing the blades.

8. The impeller device as claimed in claim 5, wherein the blades are connected to the toothed disk and the round disk by welding or by inserting the blades in grooves formed in the toothed disk and the round disk or by a connecting element which is inserted through holes formed in the blades, the toothed disk and the round disk.

9. An automatic switching regenerative charging system between kinetic energy and wind energy comprising an electric generator, and an impeller device that are directly disposed in an electric green vehicle, an input end of the impeller device is connected to a differential device through a central shaft, and a one-way clutch, an output end of the impeller device is connected to an input shaft of the electric generator.

10. The automatic switching regenerative charging system between kinetic energy and wind energy as claimed in claim 9, wherein the impeller device comprises at least one toothed disk with meshing teeth, the toothed disk is centrally formed with a central hole to be connected to the central shaft, the toothed disk is provided on at least one side thereof with plural blades radially distributed from the central hole to the meshing teeth, the respective blades have a first end connected to the toothed disk, and a second end of the respective blades is connected to a round disk which seals plural spaces defined by the plural blades.

11. The automatic switching regenerative charging system between kinetic energy and wind energy as claimed in claim 9, wherein the impeller device comprises at least one drive pulley, the drive pulley is centrally formed with a central hole to be connected to the central shaft, the drive pulley is provided at one side thereof or both sides thereof with plural blades radially distributed from the central hole, the respective blades have a first end connected to the drive pulley, and a second end of the respective blades is connected to a round disk which seals plural spaces defined by the plural blades.

12. The automatic switching regenerative charging system between kinetic energy and wind energy as claimed in claim 10 or 11, wherein the blades are flat or curved.

13. The automatic switching regenerative charging system between kinetic energy and wind energy as claimed in claim 10, wherein a central casing is engaged on the central shaft and disposed between the toothed disk and the round disk for fixing the blades.

14. The automatic switching regenerative charging system between kinetic energy and wind energy as claimed in claim 11, wherein a central casing is engaged on the central shaft and disposed between the drive pulley and the round disk for fixing the blades.

15. The automatic switching regenerative charging system between kinetic energy and wind energy as claimed in claim 10, wherein the toothed disk of the impeller device is connected to the input shaft of the electric generator through an inert gear and a driven gear.

16. The automatic switching regenerative charging system between kinetic energy and wind energy as claimed in claim 11, wherein the drive pulley is connected to the input shaft of the electric generator through a driven pulley.

17. The automatic switching regenerative charging system between kinetic energy and wind energy as claimed in claim 9, wherein the electric green vehicle is formed with air holes in a vehicle body thereof.

18. The automatic switching regenerative charging system between kinetic energy and wind energy as claimed in claim 10, wherein the blades are connected to the toothed disk and the round disk by welding or by inserting the blades in grooves formed in the toothed disk and the round disk or by inserting a connecting element into holes formed in the blades, the toothed disk and the round disk,

19. The automatic switching regenerative charging system between kinetic energy and wind energy as claimed in claim 11, wherein the blades are connected to the drive pulley and the round disk by welding or by inserting the blades in grooves formed in the toothed disk and the round disk or by inserting a connecting element into holes formed in the blades, the toothed disk and the round disk,
